(19) United States
(12) Patent Application Publication
(10) Pub. No.: US 2007/0073828 A1
(43) Pub. Date: Mar. 29, 2007

(54) Apparatus, system, and method for link layer message transfer over a durable and shared medium

(76) Inventors: Sudhir Gurunandan Rao, Portland, OE (US); Roger C. Raphael, San Jose, CA (US)

Correspondence Address: Brian C. Kunzler, Suite 600, 8 East Broadway, Salt Lake City, UT, 84111, US

(21) Appl. No.: 11/223,174

(22) Filed: Sep. 8, 2005

(51) Int. Cl. G06F 15/16

(52) U.S. Cl. 709/217; 710/39

(57) ABSTRACT

An apparatus, system, and method are disclosed for link layer message transfer. The apparatus to facilitate link layer message transfer includes a queue module, a calculation module, and a transmit module. The queue module recognizes a transmission queue element associated with an outgoing transmission queue. The transmission queue element is directed from a source host to a target host. The calculation module calculates a target host address of a message array on a shared storage device. The shared storage device is coupled to the source and target hosts. The transmit module transmits a message from the source host to the target host address of the message array on the shared storage device.

### BACKGROUND

1. Field of Art

This invention relates to data messaging and more particularly relates to reliable message transfer using a link layer protocol via a shared storage device.

2. Background Technology

Hosts connected to a global network, such as a storage area network (SAN) communicate with one another for various purposes. For example, the hosts may communicate for synchronization purposes. Many of the communications between hosts occur via an external internet protocol (IP) network, a local area network (LAN) or wide area network (WAN) that is configured to allow such communication. Such a group of hosts form a distributed system or a clustered system.

When hosts cannot communicate with one another over the external IP network for one reason or another, the distributed or clustered system results in a diminished system with reduced or zero application availability depending on the extent of the IP network fault. One reason hosts may not be able to communicate over the external IP network is if there is a failure on the IP network.

In the case where an external IP network becomes unavailable, the existing transactions on the network are generally lost. This disrupts the operation of the system and makes it more difficult for the system to subsequently resume operations, thus affecting the availability of the application.

Some conventional technologies have addressed this issue by using disk-based messaging in very limited ways. For example, some conventional technologies use disk-based heartbeats in a high availability cluster multi-processing (IBM® HACMP) environment. Additionally, some conventional technologies use a half-duplex master-subordinate messaging protocol with limited semantics in a SAN file system (IBM® SANFS). Unfortunately, these conventional technologies do not enable continuous availability of the application by way of a communication media or channel failover. From the foregoing discussion, it should be apparent that a need exists for an apparatus, system, and method that overcome the limitations of conventional disk-based messaging technologies so as to sustain application availability through IP-network faults.

### SUMMARY

The several embodiments of the present invention have been developed in response to the present state of the art, and in particular, in response to the problems and needs in the art that have not yet been fully solved by currently available disk-based messaging technologies. Accordingly, the present invention has been developed to provide an apparatus, system, and method for reliable link layer message transfer over a durable and shared medium that overcome many or all of the above-discussed shortcomings in the art. In particular, embodiments of the invention facilitate link layer communications via a message array on a shared storage device.

The apparatus to facilitate link layer message transfer is provided with a plurality of modules configured to functionally execute the necessary operations for reliable communication. In one embodiment, the apparatus includes a queue module configured to recognize a transmission queue element associated with an outgoing transmission queue, the transmission queue element intended for a target host; a calculation module configured to calculate a target host address of a message array on a shared storage device coupled to the target host; and a transmit module configured to transmit a message, including the transmission queue element, from a source host to the target host address of the message array on the shared storage device. In another embodiment, the modules also may include a receive module, an image module, a poll module, a host identification module, a LUN identification module, an array module, and a duplex module.

A system of the present invention is also presented to facilitate link layer message transfer. The system may be embodied in a data communication system. In one embodiment, the system includes a first host coupled to a shared storage device; a second host coupled to the shared storage device; and a message apparatus coupled to the first host, the message apparatus configured to transmit a message from the first host to the second host via a message array on the shared storage device.

A signal bearing medium tangibly embodying a program of machine-readable instructions executable by a digital processing apparatus to perform operations to facilitate link layer message transfer is also presented to store a program that, when executed, performs operations to facilitate link layer message transfer. In one embodiment, the operations include recognizing a transmission queue element associated with an outgoing transmission queue, the transmission queue element intended for a target host; calculating a target host address of a message array on a shared storage device coupled to the target host; and transmitting a message, including the transmission queue element, from a source host to the target host address of the message array on the shared storage device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data communication system;

FIG. 2 is a schematic block diagram illustrating one embodiment of a host;

FIG. 3 is a schematic block diagram illustrating one embodiment of a logical unit number (LUN);

FIG. 4 is a schematic block diagram illustrating one embodiment of a message apparatus;

FIG. 5 is a schematic block diagram illustrating one embodiment of a global disk identifier;

FIG. 6 is a schematic block diagram illustrating one embodiment of a message;

FIG. 7 is a schematic block diagram illustrating one embodiment of a message array;

FIG. 8 is a schematic flow chart diagram illustrating one embodiment of a system initialization method;

FIG. 9 is a schematic flow chart diagram illustrating one embodiment of a host initialization method;

FIG. 10 is a schematic flow chart diagram illustrating one embodiment of a transmission method; and

FIG. 11 is a schematic flow chart diagram illustrating one embodiment of a polling method.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

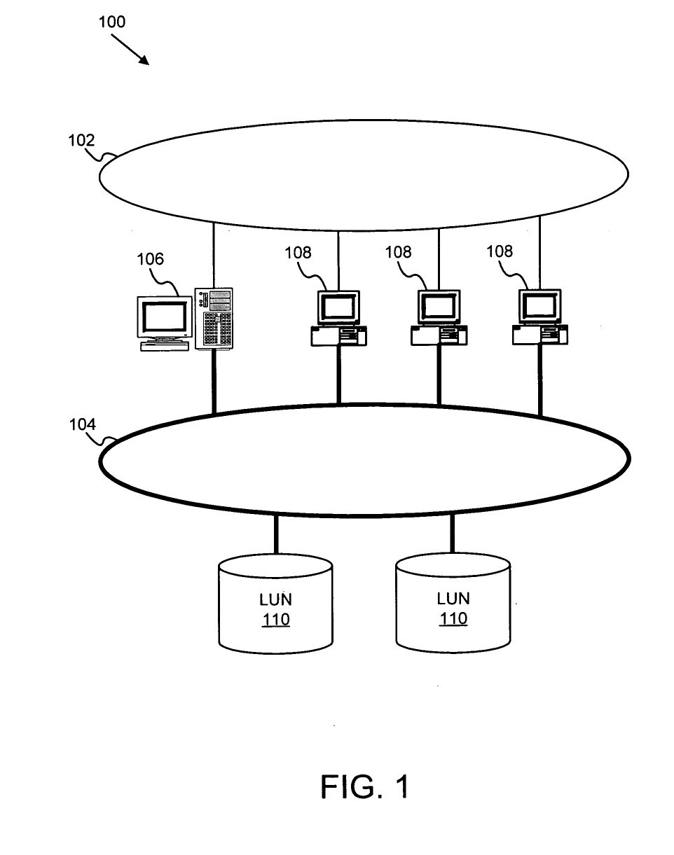

FIG. 1 depicts one embodiment of a data communication system 100. The illustrated data communication system 100 includes a first network 102 and a second network 104. In one embodiment, the first network 102 may be a local area network (LAN) or a wide area network (WAN) or another similar network that employs a data communication protocol, such as TCP/IP, for communicating data and other communications among network nodes. Reference to a LAN in the following description refers to the first network 102.

The second network 104, in one embodiment, is a storage area network (SAN) that is dedicated to data storage communications for sending storage data to or retrieving storage data from, for example, a storage resource node. In certain embodiments, the second network 104 may include a backplane cross-bar switch, a bus, any serial party-line network, etc. Reference to a SAN in the following description refers to the second network 104.

The depicted data communication system 100 also includes a storage subsystem 106 and several user computers 108. The user computers 108 also may be referred to as hosts, clients, or physical end points. In certain embodiments, the data communication system 100 may include multiple logical communication endpoints multiplexed over this single client/host based physical end point. The storage subsystem 106 and each of the several clients 108 are connected to both the LAN 102 and the SAN 104.

The SAN 104 provides a connection from the hosts, including the storage subsystem 106 and each of the clients 108, to one or more storage devices 110. The illustrated storage devices 110 are each designated as a logical unit number (LUN), which represents a virtual volume that may logically correspond to one or more physical volumes. The LUNS may emulate a standard direct access storage device (DASD) for data actually stored on the data storage devices 110, 112. In this emulation, the clients 108 (or any computer program executed by any host) view the LUNS as normal data volumes. For example, a host may view the LUN as a standard DASD, with sequentially numbered tracks, even though the LUN is only a logical representation of some of the data within the physical volumes of the data storage devices 110.

In certain embodiments, the physical volumes may comprise hard disk drives, optical disk drives, tape drives, RAM drives, or another type of device using a similar storage medium, or a combination of different storage drives and media. In general, the storage devices 110 comprise shared data storage resources and are typically used to store file data or metadata from the clients 108 or managers or servers coupled to the system 100. Each client 108 may store data on a single storage device 110 or multiple devices 110 according to a storage scheme administered at least in part by the storage subsystem 106. The subsystem 106 and the clients 108 additionally may each have one or more local storage devices (not shown).

The illustrated data communication system 100 may be referred to as a LAN-free backup system because the network topology allows the storage subsystem 106 and clients 108 to transfer file data over the SAN during backup and restore operations rather than over the LAN. Although not depicted in FIG. 1, the data communication system 100 also may include a network server, additional user computers 108, additional storage devices 110, and so forth. Additionally, this additional network equipment may or may not have access to the SAN 104.

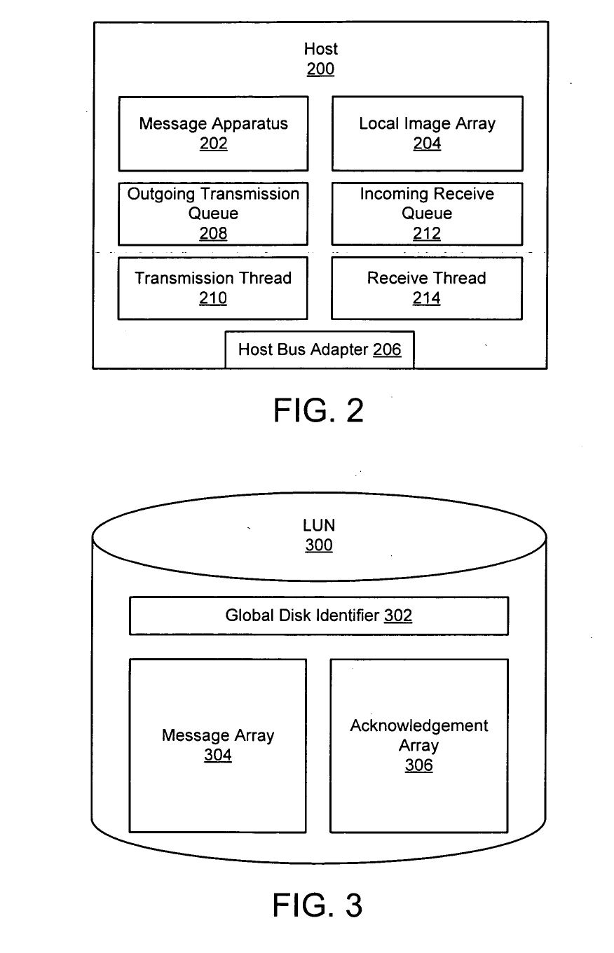

FIG. 2 depicts one embodiment of a host 200 that is representative of a client 108 or a storage subsystem 106 shown in FIG. 1. In one embodiment, the host 200 executes one or more application programs that control the operation of the host 200 and its interaction with other hosts, the LAN 102, and the SAN 104. The illustrated host 200 includes a message apparatus 202, a local image array 204, and a host bus adapter 206. The host bus adapter 206 is representative of a physical network adapter between the host 200 and the SAN 104.

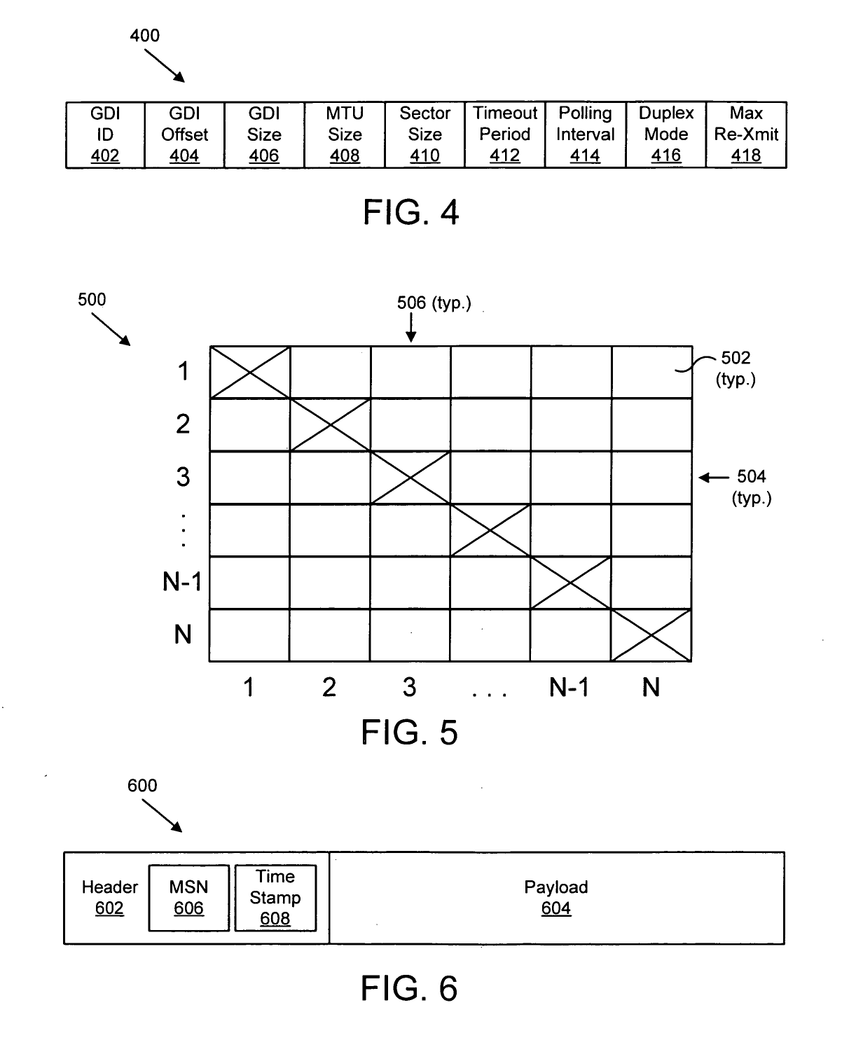

In one embodiment, the message apparatus 202 facilitates a data link layer message transfer from the host 200 to another host over the storage subsystem 106 on the SAN 104. One example of the message apparatus 202 is shown and described in more detail with reference to FIG. 4. In certain embodiments, each host 200 coupled to the SAN 104 may have an independent message apparatus 202 that is separate from the message apparatuses 202 on the other hosts.

The local image array 204, in one embodiment, is a local copy of an array that indicates which hosts have sent messages to other hosts. In particular, the local image array 204 may indicate how many messages have been sent by the host 200 on which the local image array 204 resides. In one embodiment, the local image array 204 may reside on volatile or non-volatile memory coupled to the host 200. Alternatively, the local image array 204 may reside on persistent storage media or another data storage device coupled to the host 200.

The illustrated host 200 also includes an outgoing transmission queue 208 that is serviced by a transmission thread 210 (also referred to as a transmitter). In one embodiment, the transmission thread 210 has access to transmit all outgoing messages from the host 200. In this way, the transmission thread 210 is the entity that writes to the storage devices 110.

The illustrated host 200 also includes an incoming receive queue 212 that is serviced by a receive thread 214 (also referred to as a receiver). In one embodiment, the receive thread picks up messages by polling for the messages, picking up “acknowledgements” associated with communications from the host 200, and reading the messages directed to the host 200. Additionally, the receive thread 214 may determine the presence of a posted message for the host 200 through recognition of a status change from one polling instance to another.

FIG. 3 depicts one embodiment of a LUN 300 that may be substantially similar to the LUNS described in association with the storage devices 110 of FIG. 1. The LUN 300 is globally visible and shared by two or more of the hosts 108 in the data communication system 100.

As described above, conventional LUNs typically store file data. While the illustrated LUN 300 may store file data like a conventional LUN, the depicted LUN 300 also stores a global disk identifier 302. The global disk identifier 302 uniquely identifies the LUN 300 from other LUNs in the data communication system 100. In certain embodiments, every LUN in the data communication system 100 may be assigned a unique global disk identifier. One example of the global disk identifier 302 is shown and described in more detail with reference to FIG. 4.

Additionally, the illustrated LUN 300 stores a message array 304 and possibly an acknowledgement array 306. In one embodiment, the message array 304 is an N×N array, where N represents the number of hosts available on the SAN 104. Each element of the array may have a size of a sector or another unit of storage space. The hosts are configured to use the message array to store messages directed to other hosts. The hosts may use the message array for such data link layer communications in response to a network partition between hosts that interrupts the IP communications over the LAN 102. In other words, IP network communication may be failed over to the storage-based communication via the message array when an IP network partition occurs. Alternatively, the hosts may use the data link layer message transfer via the message array in other circumstances. One example of a message array is shown and described in more detail with reference to FIG. 5.

The acknowledgement array 306, in one embodiment, may be substantially similar to the message array 304. However, in certain embodiments, the hosts may use the acknowledgement array 306 to facilitate full-duplex communications between the hosts. Without the acknowledgement array 306, hosts may communicate messages and acknowledgements to one another in a half-duplex mode by alternating use of the appropriate message array 304 element. For example, a first host may post a message for the second host, then the second host may post an acknowledgement for the first host in the same space. In full-duplex mode, however, the first host may post messages in the message array 304 and receive acknowledgements from the second host via the acknowledgement array 306. This separation permits the message and acknowledgement transmissions to happen concurrently, thereby permitting full-duplex operation.

FIG. 4 depicts one embodiment of a global disk identifier (GDI) 400 that may be substantially similar to the global disk identifier 302 shown in FIG. 3. Although certain fields are included in the illustrated global disk identifier 400, other embodiments may include more or less or other fields than are shown in FIG. 4. In certain embodiments, these fields may be configurable just as some generic systems parameters are configurable.

The illustrated global disk identifier 400 includes a GDI identification field 402, a GDI offset field 404, and a GDI size field 406. The GDI identification field 402 stores a representation of the global disk identification number that is assigned to the LUN 300 on which the GDI 400 is stored. This GDI 400 is unique from other GDIs on other LUNs 300 so that a host 200 coupled to the SAN 104 may uniquely identify each of the LUNs 300 coupled to the SAN 104. The GDI offset field 404 stores a globally agreed upon offset that indicates the position of the GDI 400 within the LUN 300. In this way, all of the hosts know where to access the GDI 400 on any of the LUNs 300. The GDI size field 406 stores an indicator of the size of the GDI 400. The size may be expressed in bytes, sectors, or any other unit of electronic storage space. Alternatively, the GDI 400 may include an array offset field that stores an indicator of the starting position of the linear representation of the message array 304, which may or may not sequentially follow the GDI 400 on the LUN 300.

The illustrated global disk identifier 400 also includes a message transfer unit (MTU) size field 408, a sector size field 410, and a timeout period field 412. The MTU size field 408 stores the message transfer unit (MTU), or standard size of the messages communicated between hosts via the message apparatus 202. The MTU may be expressed in bytes, sectors, or any other units of storage space. In one embodiment, the MTU may be six sectors. The MTU also may be used to indicate the size of each element within the message array 304. The timeout period field 412 stores a timeout indicator that defines the amount of time during which a communication operation may continue prior to failure of the communication operation. Alternatively, the timeout indicator may define a number of retry attempts that may be executed before the attempted communication operation fails.

The illustrated global disk identifier 400 also includes a polling interval field 414, a duplex mode field 416, and a maximum retransmission field 418. The polling interval field 414 stores a polling indicator that defines the length of time between polling operations, in which a host 200 may poll a message array 304 to determine if any new messages, acknowledgements, or responses (depending on the mode of operation) have been posted to the message array 304. The duplex mode field 416 stores a duplex indicator that indicates if the data communication system 100 is operating in half-duplex mode or fill-duplex mode. The maximum retransmission field 418 stores an indicator that designates how many times a host 200 may attempt to retransmit a message before failing a communication operation.

FIG. 5 depicts one embodiment of a message array 500 that is a two-dimensional representation of the message array 304 shown in FIG. 3. The illustrated message array 500 includes a plurality of elements 502 shown in a number of rows 504 and columns 506. Each row 504 corresponds to a host 200 within the data communication system 100. Similarly, each column 506 corresponds to a host 200 within the data communication system 100. This results in a message array 500 that has N×N elements 502, where the data communication system 100 includes N hosts. In one embodiment, each element 502 may have a size equal to one MTU. For example, each element 502 may be six sectors. Furthermore, in one embodiment, each host 200 is given an absolute and unique integer identifiers in the range of [1 . . . N], which does not change during the lifetime of the host.

The rows 504 and columns 506 of the message array 500 may correspond to the sending host 200 and polling host (not shown), respectively, or vice-versa. Therefore, each row 504 and column 506 has a corresponding designation of 1,2,3, . . . , N−1, N, which each correspond to one of the N hosts coupled to the SAN 104. For convenience in describing the message array 500, however, this description will use the convention that each column 506 corresponds to a sending host 200 and each row 504 corresponds to a receiving host. Additionally, it may be possible for a sending host 200 to be the same as the receiving host, in which case the corresponding element 502 would be one of the elements 502 along the principal diagonal (shown by the “x”-es) of the array 500. Although the message array 500 is shown with the diagonal “dead spaces,” alternative embodiments may employ arrays or other configurations that do not employ such dead spaces. As used herein, “dead spaces” refer to locations within the message array 500 that are not expected or permitted to be used.

As an example, if host 4 communicates a message to host 3 in a system having 8 hosts, the message is posted in element (3,4). Similarly, if host 8 communicates a message to host 2, the message is posted in element (2,8). These elements are shown in bold in Table 1. In this way, each host 200 can poll a given row 504 within the message array 500 to determine if any messages have been posted for that host. In the example shown, host 3 will find the message posted by host 4 upon polling row 3. Similarly, host 2 will find the message posted by host 8 upon polling row 2.

TABLE 1
Sample Message Array with Posted Messages

| Sending Host | | | | | | | |
|---|---|---|---|---|---|---|---|
| 1 | 2 | 3 | 4 | 5 | 6 | 7 | 8 |

| | | | | | | | | | |
|---|---|---|---|---|---|---|---|---|---|
| Polling | 1 | (1, 1) | (1, 2) | (1, 3) | (1, 4) | (1, 5) | (1, 6) | (1, 7) | (1, 8) |
| Host | 2 | (2, 1) | (2, 2) | (2, 3) | (2, 4) | (2, 5) | (2, 6) | (2, 7) | (2, 8) |
| | 3 | (3, 1) | (3, 2) | (3, 3) | (3, 4) | (3, 5) | (3, 6) | (3, 7) | (3, 8) |
| | 4 | (4, 1) | (4, 2) | (4, 3) | (4, 4) | (4, 5) | (4, 6) | (4, 7) | (4, 8) |
| | 5 | (5, 1) | (5, 2) | (5, 3) | (5, 4) | (5, 5) | (5, 6) | (5, 7) | (5, 8) |
| | 6 | (6, 1) | (6, 2) | (6, 3) | (6, 4) | (6, 5) | (6, 6) | (6, 7) | (6, 8) |
| | 7 | (7, 1) | (7, 2) | (7, 3) | (7, 4) | (7, 5) | (7, 6) | (7, 7) | (7, 8) |
| | 8 | (8, 1) | (8, 2) | (8, 3) | (8, 4) | (8, 5) | (8, 6) | (8, 7) | (8, 8) |

In order to store the message array 500 in the LUN 300, the message array 500 may be converted from a two-dimensional array to a linear array. In one embodiment, a mathematical algorithm may be implemented to facilitate such conversion. For example, the following algorithm may be used to convert a two-dimensional array to a linear array.
f(i,j)=N*(i−1)+j,
where f(i,j) is the new location in the linear array, N is the total number of hosts represented in the message array 500, i is the host identifier (between 1 and N) corresponding to the polling host, and j is the host identifier (between 1 and N) corresponding to the sending host. Alternatively, the function may be modified as f(i,j)=N*(i−1)+(j−1) for a given set of hosts identified between 0 and N−1.

The following table, Table 2, shows the new element locations of each element from a multi-dimensional array converted into a linear array using the algorithm shown above. Referring again to the example discussed above with Table 1, Table 2 highlights the converted values for elements (2,8) and (3,4), according to the given algorithm. Alternatively, other mathematical algorithms or variations thereof may be implemented to provide a linear representation of a multi-dimensional array. Additionally, the starting location of the linear array may be affected by the GDI offset, the location and size of the GDI 400, or other data stored on the LUN 300. Although the previous examples are arbitrary, similar communications may occur between each pair of sending and polling hosts.

TABLE 2
Converted Element Locations within a Linear Array

| | | Sending Host | | | | | | | |
|---|---|---|---|---|---|---|---|---|---|
| | | 1 | 2 | 3 | 4 | 5 | 6 | 7 | 8 |
| Polling Host | 1 | 1 | 2 | 3 | 4 | 5 | 6 | 7 | 8 |
| | 2 | 9 | 10 | 11 | 12 | 13 | 14 | 15 | 16 |
| | 3 | 17 | 18 | 19 | 20 | 21 | 22 | 23 | 24 |
| | 4 | 25 | 26 | 27 | 28 | 29 | 30 | 31 | 32 |
| | 5 | 33 | 34 | 35 | 36 | 37 | 38 | 39 | 40 |
| | 6 | 41 | 42 | 43 | 44 | 45 | 46 | 47 | 48 |
| | 7 | 49 | 50 | 51 | 52 | 53 | 54 | 55 | 56 |
| | 8 | 57 | 58 | 59 | 60 | 61 | 62 | 63 | 64 |

FIG. 6 depicts one embodiment of a message 600 that may be communicated from one host 200 to another via the message array 500. The illustrated message 600 includes header data 602 (also referred to as the header) and payload data 604 (also referred to as the payload). The header 602 may include information about the payload 604 and the message 600, as well as the host identifier. For example, the header 602 may include a message sequence number (MSN) 606 and a time stamp 608. The message sequence number, in one embodiment, corresponds to the message 600. Each time a message is sent or resent, the message sequence number is incremented so that each message 600 is uniquely identified relative to other messages 600. The message sequence number may be particular to a pair of hosts (i.e. one MSN associated with each element 502 of the message array 500) or may be global across the message array 500 as a whole. The time stamp 608 indicates the approximate time that the message 600 was sent by the source host 200 or, alternatively, posted to the message array 500.

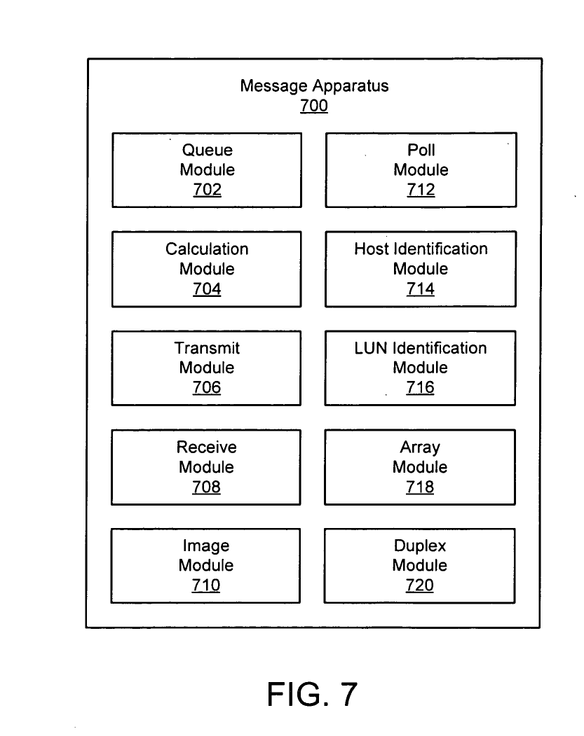

FIG. 7 depicts one embodiment of a message apparatus 700 that may be substantially similar to the message apparatus 202 shown in FIG. 2. The illustrated message apparatus 700 includes a queue module 702, a calculation module 704, and a transmit module 706. The illustrated message apparatus 700 also includes a receive module 708, an image module 710, a poll module 712, a host identification module 714, a LUN identification module 716, an array module 718, and a duplex module 720. Other embodiments of the message apparatus 700 may include fewer or more modules than are shown in FIG. 7.

In one embodiment, the queue module 702 recognizes a transmission queue element that is in the outgoing transmission queue 208. The transmission queue element is intended for a target host 200 that is coupled to the source host 200 to which the message apparatus 700 is coupled. The target host 200 may be designated within the header 602 or other metadata associated with the payload 602 of the transmission queue element.

In one embodiment, the calculation module 704 calculates a target host address within the message array 304 on the LUN 300. The target host address corresponds to an array element 502 within the message array 500 that the target host 200 polls for detection and retrieval of messages 600 directed to the target host. In one embodiment, the calculation module 704 calculates the target host address according to a mathematical algorithm, such as the algorithm describe above. Alternatively, the calculation module 704 may determine the target host address in another manner.

In one embodiment, the transmit module 706 transmits a message 600 from the source host 200 to the target host 200 via the message array 500 on the shared LUN 110. In certain embodiments, the transmit module 706 may transmit the message 600 while the data communication system 100 is operating in either half-duplex or full-duplex mode, as described above.

In one embodiment, the receive module 708 retrieves a posted message for a target host 200 from an array element 502 for the corresponding target host. For example, the receive module 708 located on host 3 may retrieve a message sent from host 4 and posted to element (3,4) of the message array 500.

In one embodiment, the image module 710 creates the local image array 204 that is shown and described with reference to FIG. 2. The local image array 204 may be simply a local copy of the message array 500. Alternatively, the local image array 204 may be a local copy of a subset of the message array 500. By maintaining a local copy 204 of the message array 500 on each host, the message apparatus 700 may determine if the message array 500 has been changed, which indicates that a new message or acknowledgement is posted in the message array 500. In particular, the local image array 204 may include the message sequence numbers 606 and time stamps 608 so that these can be compared against the message sequence numbers 606 and time stamps 608 associated with the actual messages 600 posted in the message array 500.

In one embodiment, the poll module 712 polls the array elements 502 corresponding to a given host 200 to determine if a message 600 is posted for the host. For example, the poll module 712 located on host 3 may poll all of the array elements (3,1) through (3,8) so that the message apparatus 700 may determine if any the these array elements 502 include new messages.

In one embodiment, the host identification module 714 assigns a unique global host identifier to each of the hosts 200 coupled to the SAN 104. As described above, this host identifier may remain constant during the life of the host 200. Additionally, the host identification module 714 may recognize all of the hosts coupled to the SAN 104 upon initialization of the data communication system 100 or a host. In a further embodiment, the host identification module 714 may communicate to each host 200 the total number of hosts (e.g. N) coupled to the SAN 104 or to one or more of the shared storage devices 110.

In one embodiment, the LUN identification module 716 recognizes a shared storage device 110 and assigns a global disk identifier 400 to the shared storage device 110. In a further embodiment, the LUN identification module 716 may recognize and assign unique global disk identifiers 400 to each of the shared LUNs 110 coupled to the SAN 104.

In one embodiment, the array module 718 creates the message array 500 on the LUN 110. Additionally, the array module 718 may facilitate creation of an acknowledgement array (not shown) on the LUN 110 for use in full-duplex mode. In another embodiment, the array module 718 also may initialize a message sequence number (MSN) 606 for each of the hosts coupled to the SAN 104. In a further embodiment, the array module 718 may assign a message sequence number 606 to each outgoing message 600 from a host.

In one embodiment, the duplex module 720 indicates whether the data communication system 100 operates in half-duplex or full-duplex mode. In half-duplex mode, the message apparatus 700 uses a single array, the message array 500, to facilitate data link layer communications among hosts coupled to the SAN 104. The message array 500 is used to post messages 600 from the source host 200 and acknowledgements from the target host 200 for each communication. In one embodiment of the full-duplex module, the message apparatus 700 uses two message arrays, the message array 500 and an acknowledgement array, to facilitate data link layer communications among the hosts. The message array 500 is used to post messages 600 from the source host. The acknowledgement array is used to post acknowledgements from the target host.

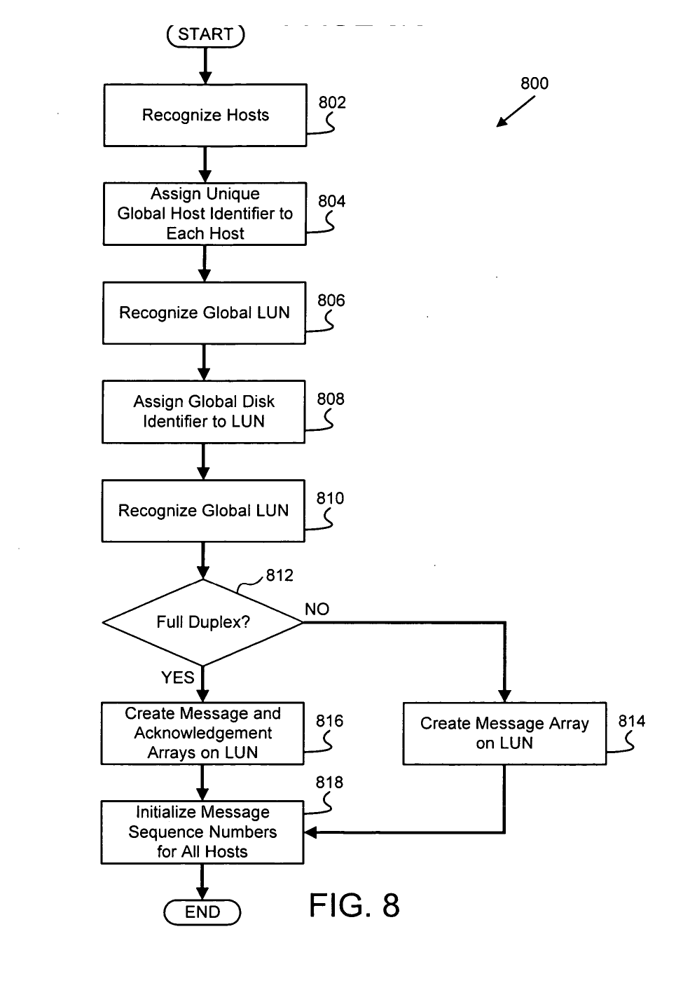

FIG. 8 depicts one embodiment of a system initialization method 800 that may be implemented in conjunction with the message apparatus 700 of FIG. 7. In situations where the data communication system 100 includes multiple hosts 200, the system initialization method 800 may be performed by a single message apparatus 700 on a single host 200 or, alternatively, may be performed by the combination of two or more message apparatuses 700 on separate hosts 200. For convenience in describing the system initialization method 800, the following description will describe the method 800 as it might be performed by a single host 200 and message apparatus 700. Furthermore, although some of the operations of the method 800 are described as being performed by a particular module of the message apparatus 700, other embodiments may incorporate other modules in addition to or in place of the referenced modules.

The illustrated system initialization method 800 begins and the host identification module 714 recognizes 802 all of the hosts coupled to the SAN 104. The host identification module 714 then assigns 804 a unique global host identifier to each of the individual hosts. The LUN identification module 716 also recognizes 806 one or more shared storage devices 110 or LUNs 300. The LUN identification module 716 then assigns 808 a global disk identifier 400 to the LUN 300. Alternatively, the LUN identification module 716 may assign 808 a unique global disk identifier to each of the shared LUNs 300. The host identification module 714 and LUN identification module 716 also stores 810 the total number of hosts, N, and the global disk identifier 400 at the appropriate location on the LUN 300.

The array module 718 also determines 812 if the data communication system 100 is operating in half-duplex or full-duplex mode and creates the corresponding arrays. In one embodiment, the array module 718 may employ the duplex module 720 to determine 812 the duplex mode of the data communication system 100. If operating in half-duplex mode, the array module 718 creates 814 only the message array 304 on the LUN 300. If operating in full-duplex mode, the array module 718 also creates 816 the acknowledgement array 306 on the LUN 300. Subsequently, the array module 718 initializes 818 the message sequence numbers 606 for all of the hosts. The depicted system initialization method 800 then ends.

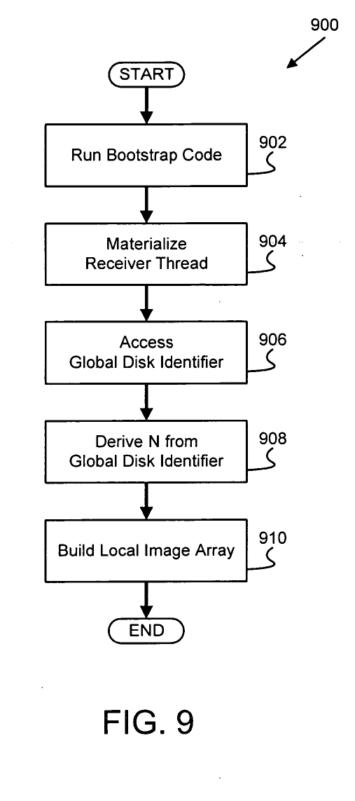

FIG. 9 depicts one embodiment of a host initialization method 900 that may be implemented in conjunction with the message apparatus 700 of FIG. 7. Each host 200 may perform the host initialization method 900 upon startup or when logically connected to the SAN 104. Although some of the operations of the method 900 are described as being performed by a particular module of the message apparatus 700, other embodiments may incorporate other modules in addition to or in place of the referenced modules.

The illustrated host initialization method 900 begins and the host 200 runs 902 a bootstrap code, which may include code to search and identify the LUN(s) 110 that are involved with this communication system. In one embodiment, the global disk identifier 400 has been recorded in the system initialization method 800. All available LUN[s] 110 are scanned to locate the appropriate ones having a GDI 400. All relevant information and parameters pertaining to the system as in 400 are subsequently derived. In one embodiment, the host 200 decides whether or not to participate in the link layer communications based on a configuration or persistent state external to the host 200, which may be set up via a graphical or command-line user interface.

The receive module 708 then materializes 904 the receive thread 214 and its associated receive queue. The transmit module 706 then materializes the transmitter thread 210 and its associated transmit queue. The poll module 712 then derives 908 the total number of hosts 200 (N) from the global disk identifier 400 and also determines if the system needs to operate in full or half duplex mode. In an alternative embodiment, full or half duplex communication may be characteristic and specific only to a communicating pair of hosts in this system rather than global to the system. Subsequently, the image module 710 builds 910 the local image array 204 on or near the host 200. In one embodiment, the image module 710 saves the contents of the message array 500 in the local image array 204. The depicted host initialization method 900 then ends.

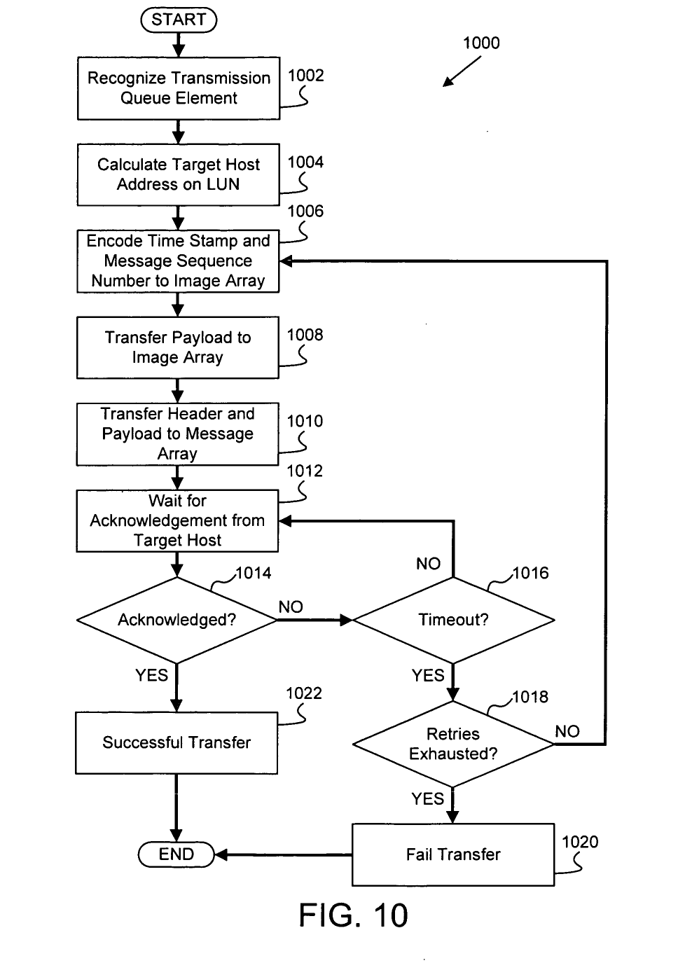

FIG. 10 depicts one embodiment of a transmission method 1000 that may be used in conjunction with the message apparatus 700 of FIG. 7. Although the transmission method 1000 is described herein principally with reference to a source host 200, any of the hosts 200 coupled to the SAN 104 may be a source host 200. Although some of the operations of the method 1000 are described as being performed by a particular module of the message apparatus 700, other embodiments may incorporate other modules in addition to or in place of the referenced modules.

The illustrated transmission method 1000 begins and the queue module 702 recognizes 1002 a transmission queue element on the outgoing transmission queue 208. The calculation module 704 then calculates 1004 a target host address of the message array 500. In one embodiment, the target host address is based, at least in part, on the host identifiers of the source and target hosts 200. The image module 710 then encodes 1006 a time stamp 608 and message sequence number 606 and stores these in the image array 204 in the corresponding array element. The image module 710 also stores 1008 a copy of the payload 604 in the image array 204.

The transmission module 706 then transmits the header 604 and payload 604 of the message 600 to the message array 304 on the shared LUN 300. The message apparatus 700 then waits 1012 for an acknowledgement from the target host 200. In one embodiment, the message apparatus 700 waits until a timeout period expires 1016. The timeout period may be established at a duration that is sufficient to allow the target host 200 to acknowledge the presence of the message 600 in the message array 304. If the timeout period does expire 1016, then the message apparatus 700 determines 1018 if the communication operation has exhausted a maximum number of retries. If the communication has exhausted a maximum number of retries, the message apparatus 700 fails 1020 the communication operation. Otherwise, if the retries have not been exhausted 1018, then the image module 710 and transmit module 708 iteratively transfer the data to the image array 204 and the message array 304, respectively. Each time the image module encodes 1006 the message sequence number 606 for a message 600, the message sequence number 606 may be incremented by one, for example, to distinguish the message retry from the original message attempt.

If the message apparatus 700 does receive an acknowledgement from the target host 200, then the transmission method 1000 ends successfully 1022. Otherwise, the communication operation fails 1020 and the depicted transmission method 1000 ends without having completed the data link layer transfer.

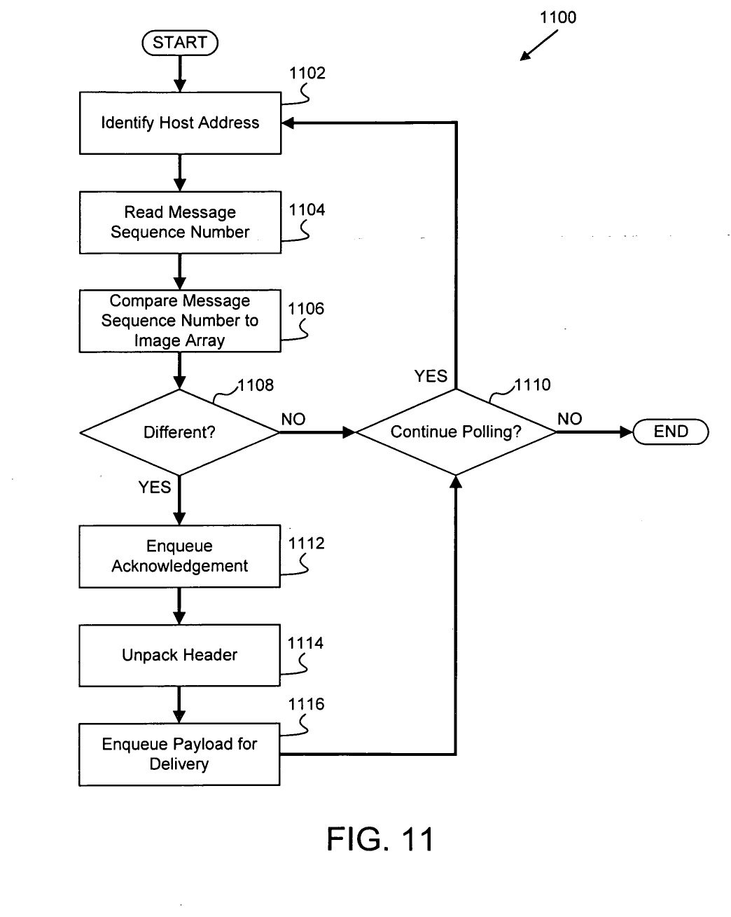

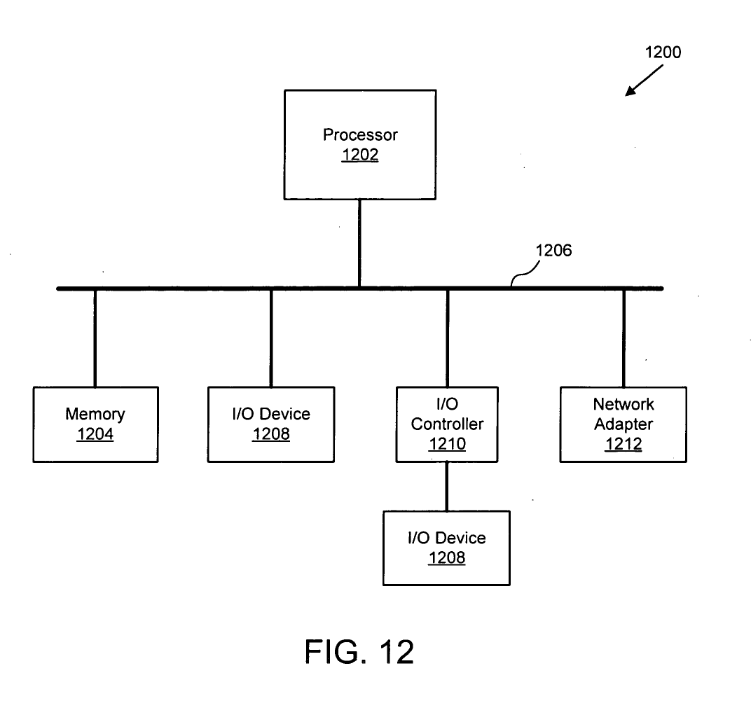

FIG. 11 depicts one embodiment of a polling method 1100 that may be used in conjunction with the message apparatus 700 of FIG. 7. Although one method of polling is described herein, alternative polling methods may be implemented to determine if a message is posted to the message array 500. Furthermore, although some of the operations of the method 1100 are described as being performed by a particular module of the message apparatus 700, other embodiments may incorporate other modules in addition to or in place of the referenced modules.

The illustrated polling method 1100 begins and the poll module 712 identifies 1102 a host address in either the message array 304 (in the case of half-duplex operation) or the acknowledgement array 306 (in the case of full-duplex operation). For convenience in describing the polling method 1100, the following description will describe the poll method 1100 as it may be performed in half-duplex mode. As described above, half-duplex mode only employs the message array 304 and not the acknowledgement array 306. In comparison, the full duplex mode may employ the acknowledgement array 306 in addition to the message array 304.

The poll module 712 then reads 1104 the message sequence number 606 of the message 600 associated with the host address and compares 1106 the message sequence number 606 in the message array 304 with the message sequence number 606 stored in the local image array 204. If the poll module 712 determines 1108 that the message sequence numbers 606 are not different, then the poll module 712 may continue 1110 polling, as described above, to determine if a message is posted to the message array 304.

However, if the poll module 712 determines 1108 that the message sequence numbers 606 are different, then the receive module 708 retrieves the message from the message array 304 and enqueues 1112 an acknowledgement to be sent to the message array 304. The receive module 708 subsequently unpacks 1114 the header 602 and enqueues 1116 the payload 604 for delivery. The depicted polling method 1100 then ends.

The invention can take the form of an entirely hardware embodiment, an entirely software embodiment or an embodiment containing both hardware and software elements. In one embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

FIG. 12 depicts one embodiment of a data processing system 1200 suitable for storing and/or executing program code. The illustrated data processing system 1200 includes at least one processor 1202 coupled directly or indirectly to memory elements 1204 through a system bus 1206. The memory elements 1204 can include local memory employed during actual execution of the program code, bulk storage, and cache memories which provide temporary storage of at least some program code in order to reduce the number of times code must be retrieved from bulk storage during execution.

Input/output or I/O devices 1208 (including but not limited to keyboards, displays, pointing devices, etc.) can be coupled to the system bus 1206 either directly or through intervening I/O controllers 1210.

Network adapters 1212 may also be coupled to the system bus 1206 to enable the data processing system 1200 to become coupled to other data processing systems (not shown) or remote printers or storage devices (not shown) through intervening private or public networks (not shown). Modems, cable modem and Ethernet cards are just a few of the currently available types of network adapters.

In addition to the advantages described above, certain embodiments facilitate the use of higher level protocols on top of the link layer communications to potentially achieve a complete standard protocol and interface for message passing among hosts. Furthermore, data link layer communications may provide continuous availability of a cluster or a distributed system during such time as a network is in disrepair. In particular, the data link layer communications described above may offer sufficient bandwidth to pass messages within a cluster environment. In such a situation, the IP-network communication may be failed over to the shared storage communication channel, thus providing continuous availability of the entire system without a drop in service level.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to facilitate link layer message transfer, the apparatus comprising:
a queue module configured to recognize a transmission queue element associated with an outgoing transmission queue, the transmission queue element intended for a target host;
a calculation module coupled to the queue module, the calculation module configured to calculate a target host address of a message array on a shared storage device coupled to the target host; and
a transmit module coupled to the calculation module, the transmit module configured to transmit a message, including the transmission queue element, from a source host to the target host address of the message array on the shared storage device.

2. The apparatus of claim 1, further comprising a poll module coupled to the calculation module, the poll module configured to periodically poll a plurality of source host addresses within the message array.

3. The apparatus of claim 2, further comprising a receive module coupled to the poll module, the receive module configured to retrieve a posted message from one of the plurality of source host addresses.

4. The apparatus of claim 1, further comprising an image module coupled to the transmit module, the image module configured to create a local image array accessible by the source host and to update the local image array with payload data from the message and metadata, including a message sequence number, associated with the message.

5. The apparatus of claim 1, wherein the message comprises header data and payload data.

6. The apparatus of claim 1, wherein the calculation module is further configured to calculate the target host address according to a mathematical algorithm that correlates a multi-dimensional array to a linear array.

7. The apparatus of claim 1, further comprising a host identification module coupled to the transmit module, the host identification module configured to:
recognize the source host and the target host coupled to the shared storage device;
assign a unique global host identifier to each of the source host and the target host; and
communicate to the source host and the target host a total number of hosts coupled to the shared storage device.

8. The apparatus of claim 1, further comprising a logical unit number (LUN) identification module coupled to the transmit module, the LUN identification module configured to:
recognize the shared storage device; and
assign a global disk identifier to the shared storage device.

9. The apparatus of claim 1, further comprising an array module coupled to the transmit module, the array module configured to create the message array on the shared storage device.

10. The apparatus of claim 9, the array module further configured to create an acknowledgement array on the shared storage device.

11. The apparatus of claim 9, wherein the array module is further configured to initialize a message sequence generator for the source host and to assign a message sequence number to the message.

12. The apparatus of claim 1, further comprising a duplex module coupled to the transmit module, the duplex module configured to indicate a duplex mode of the message array.

13. A system to facilitate link layer message transfer, the system comprising:
a first host coupled storage device;
a second host coupled to the shared storage device; and
a message apparatus coupled to the first host, the message apparatus configured to transmit a message from the first host to the second host via a message array on the shared storage device.

14. The system of claim 13, further comprising a storage area network (SAN) coupled to the first host and the second host, the message apparatus configured to transmit the message over the SAN network.

15. The system of claim 13, wherein the message apparatus is further configured to implement link layer messaging in response to a network partition between the first host and the second host.

16. A signal bearing medium tangibly embodying a program of machine-readable instructions executable by a digital processing apparatus to perform operations to facilitate link layer message transfer, the operations comprising:
recognizing a transmission queue element associated with an outgoing transmission queue, the transmission queue element intended for a target host;
calculating a target host address of a message array on a shared storage device coupled to the target host; and
transmitting a message, including the transmission queue element, from a source host to the target host address of the message array on the shared storage device.

17. The signal bearing medium of claim 16, wherein the instructions further comprise an operation to periodically poll a plurality of source host addresses within the message array and retrieve a posted message from one of the plurality of source host addresses.

18. The signal bearing medium of claim 16, wherein the instructions further comprise an operation to create a local image array accessible by the source host and to update the local image array with payload data from the message and metadata, including a message sequence number, associated with the message.

19. The signal bearing medium of claim 16, wherein the instructions further comprise an operation to:
recognize the source host and the target host coupled to the shared storage device;
assign a unique global host identifier to each of the source host and the target host; and
communicate to the source host and the target host a total number of hosts coupled to the shared storage device.

20. The signal bearing medium of claim 16, wherein the instructions further comprise an operation to:
recognize the shared storage device;
assign a global disk identifier to the shared storage device;
create the message array on the shared storage device; and
create an acknowledgement array on the shared storage device.
